(19) United States
(12) Patent Application Publication
(10) Pub. No.: US 2014/0211263 A1
(43) Pub. Date: Jul. 31, 2014

(54) IMAGE PROCESSING APPARATUS, IMAGE PROCESSING METHOD, AND RECORDING MEDIUM

(71) Applicant: Ryo Kobayashi, Kanagawa (JP)

(72) Inventor: Ryo Kobayashi, Kanagawa (JP)

(73) Assignee: RICOH COMPANY, LTD., Tokyo (JP)

(21) Appl. No.: 14/138,231

(22) Filed: Dec. 23, 2013

(30) Foreign Application Priority Data
Jan. 28, 2013 (JP) 2013-013256

(51) Int. Cl. G06K 15/00; G06K 15/02

(52) U.S. Cl. CPC G06K 15/407; G06K 15/1807
USPC 358/2.1; 358/3.24

(57) ABSTRACT

An image processing apparatus includes a first determination unit determining an attribute of an image data described in a page description language; a second determination unit determining whether there exists a data having high color saturation in the image data; a third determination unit determining a main hue in the image data; and a determination unit determining an optimal printing method for printing the image data based on determination results by the first, the second, and the third determination units.

### CROSS-REFERENCE TO RELATED APPLICATIONS

The present application is based on claims the benefit of priority under 35 U.S.C §119 of Japanese Patent Application No. 2013-013256 filed on Jan. 28, 2013, the entire contents of which are hereby incorporated herein by reference.

### BACKGROUND OF THE INVENTION

1. Field of the Invention

The present invention generally relates to an image processing apparatus, an image processing method and a program for lower-cost printing.

2. Description of the Related Art

As an example method of reducing printing cost in an image processing apparatus such as a printer, there is a method for saving toner by reducing a toner consumption amount by reducing the image density to be lower than a predetermined density and a method of low-cost printing such as two-color printing where black and a designated color are used for printing a full-color draft.

To that end, for example, Japanese Laid-open Patent Publication No. 2010-122387 discloses a technique in which a toner-consumption-reduced image, which shows a (simulated) result of printing when the toner consumption is reduced, is displayed in preview to avoid useless printing based on the reduced amount of toner.

### SUMMARY OF THE INVENTION

According to an aspect of the present invention, an image processing apparatus includes a first determination unit determining an attribute of image data described in a page description language; a second determination unit determining whether there exists data having high color saturation in the image data; a third determination unit determining a main hue in the image data; and a determination unit determining an optimal printing method for printing the image data based on determination results by the first, the second, and the third determination units.

### BRIEF DESCRIPTION OF THE DRAWINGS

Other objects, features, and advantages of the present invention will become more apparent from the following description when read in conjunction with the accompanying drawings, in which:

FIG. 1 illustrates an example configuration of an image forming apparatus according to an embodiment of the present invention;

FIG. 2 is a flowchart illustrating an example determination process by a toner consumption reduction mode determination section according to an embodiment;

FIG. 3 illustrates an example configuration of a color saturation determination section according to an embodiment;

FIG. 4 illustrates an example conversion formula from RGB to HSV;

FIG. 5 illustrates an example configuration of a main attribute determination section according to an embodiment;

FIG. 6 illustrates example classification of an objection in image data;

FIG. 7A illustrates an example configuration of the main attribute determination section according to an embodiment;

FIG. 7B illustrates an example hue determination table in a main hue determination section according to an embodiment;

FIG. 7C is a graph illustrating a result of counted number of pixels in the image data for each hue; and

FIG. 8 illustrates an example γ table used in a toner saving mode.

### DETAILED DESCRIPTION OF THE PREFERRED EMBODIMENTS

In related-art low-cost printing, there is a trade-off relationship between reduced toner consumption amount and the image quality. Namely, when such low-cost printing is performed, the image quality is reduced so that the result of the printing may be useless. For example, in a toner-saving mode, when image data include many characters and lines, the characters and the lines are likely to be seamless, so that the visibility may be remarkably impaired.

Further, when two-color printing is performed, the color information of the characters and lines is changed to a designated color (i.e., cyan, magenta, yellow, red, green, blue or the like). Therefore, an object of the color printing may be achieved. However, for example, all colors except the achromatic color (black) are replaced by the designated color, a mixed image of black and the designated color is formed, which may become an abnormal image. Namely, to prevent the image quality from being remarkably impaired, it is desired to perform low-cost printing in accordance with the image.

However, in low-cost printing in related technologies, it is necessary for the user to be involved to determine and select which of the low-cost printings is acceptable (appropriate).

The present invention is made in light of the problem, and may provide an image processing apparatus, an image processing method, and a program for performing appropriate low-cost printing in accordance with the image data to be printed.

In the following, embodiments of the present invention are described in detail with reference to the accompanying drawings.

According to an embodiment of the present invention, it becomes possible to automatically perform an optimal low-cost printing in accordance with features of the image data such as color saturation information, hue information, object information and the like.

### First Embodiment

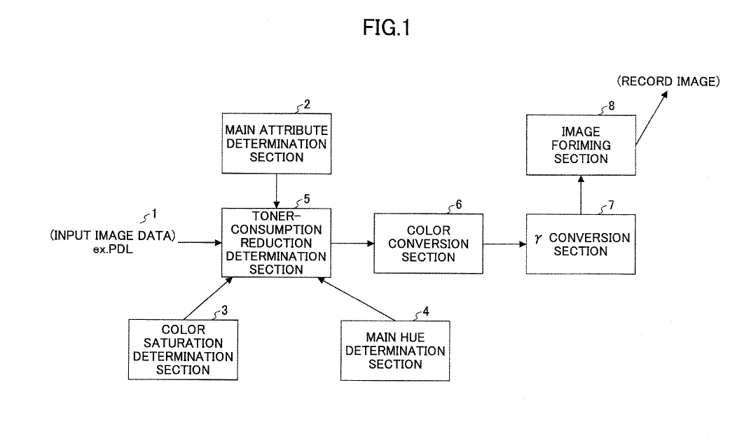

FIG. 1 illustrates an example configuration of an image processing apparatus according to an embodiment of the present invention. As illustrated in FIG. 1, the image processing apparatus includes a main attribute determination section 2, a color saturation determination section 3, a main hue determination section 4, a toner-consumption reduction mode determination section 5, a color conversion section 6, a γ conversion section 7, and an image forming section 8. Further, the numeral reference “1” denotes input image data.

The input image data 1 are described in a page description language (PDL), and include positional information of an image object in the input image, color data, and attribute data to determine whether a target object is an image, text, or graphic.

The color saturation determination section 3 analyzes the color data in the input image data 1 and determines whether the input image data 1 include the color data having high color saturation (a.k.a. chrome, colorfulness, color intensity and the like).

The main hue determination section 4 analyzes the color data in the input image data 1 and determines the hue that is most frequently used among CMYRGB hue.

The main attribute determination section 2 analyzes the attribute information in the input image data 1, calculates an area of an image object, an area of a graphic object, and an area of a text object in the image data, and determines which object has an attribute that is dominant (principal) in the image data 1 from among three kinds of attributes classifying the image, the graphic, and the text objects.

The toner-consumption reduction mode determination section 5 determines (selects) which of the monochrome printing, the toner-saving printing, or the two-color printing is to be performed based on the determination results by the main attribute determination section 2, the color saturation determination section 3, and the main hue determination section 4.

When the two-color printing is determined to be performed, the toner-consumption reduction mode determination section 5 further determines the combination of the colors to be used in the two-color printing based on the determination result by the main hue determination section 4.

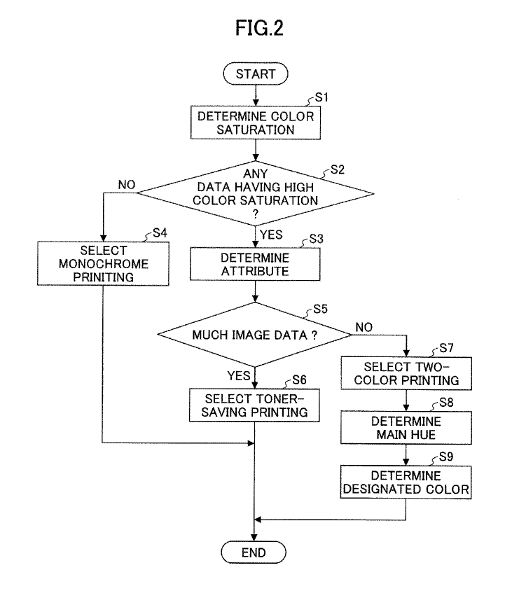

FIG. 2 is a flowchart illustrating an example determination method executed by the toner-consumption reduction mode determination section 5.

As illustrated in FIG. 2, in step S1, the color saturation determination section 3 calculates the color saturation in the input image data 1, and determines whether a color having the color saturation greater than or equal to a predetermined color saturation exists in the input image data 1. Generally, the greater the color saturation of the color, the more frequently the color is used in a part to be highlighted in the document.

In contrast, when the monochrome printing performed, the highlighting effect using a color may be eliminated, so that the information may not be sufficiently presented. In this regard, generally, a color having low color saturation may not be sufficiently highlighted in a document. Also, when the document is converted into monochrome data, the color difference from the color data is (relatively) small.

Accordingly, when there exists a color having high color saturation in the data, it may not be appropriate to print the data in the monochrome printing. However, if image data are formed in colors having low color saturation only, the image data may be printed practically in the monochrome printing.

Therefore, in step S4, when it is determined that there are no data having the color saturation greater than or equal to the predetermined color saturation (NO in step S2), the toner-consumption reduction mode determination section 5 according to this embodiment selects the monochrome printing.

When there is no substantial information difference whether the color printing or the monochrome printing is performed on the image that is determined to be printed in the color printing in step S4, an image processing where color toner consumption is reduced may be performed.

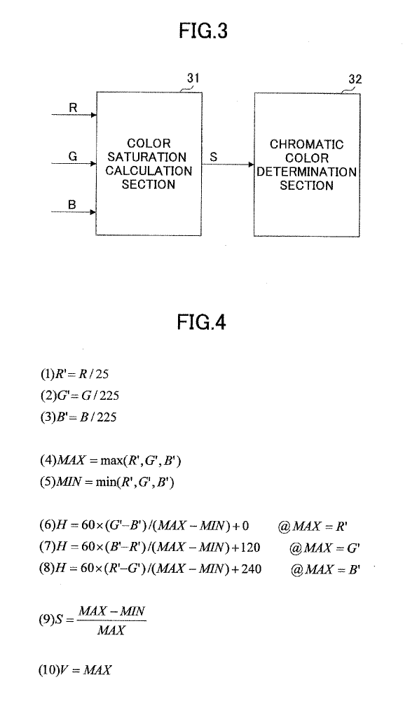

The method of calculating the color saturation and the determination method will be described with reference to FIGS. 3 and 4.

In step S3, when there exist color data having high color saturation and it is indispensable to use a color toner (YES in step S2), it is further determined whether the two-color printing or the toner-saving printing is to be performed.

Here, the “two-color printing” refers to a method where two colors that are black as a base color and one designated color selected from among cyan, magenta, yellow, red, blue, and green are used to form an image. By doing this, a highlighting effect due to the two colors may be realized at lower cost than that in the full-color printing.

Further, the “toner-saving printing” herein refers to a printing in which the toner-consumption amounts are reduced by reducing the density of the image by uniformly reducing the values in the printer γ tables of the full-color data in cyan, magenta, yellow, and black colors as illustrated in FIG. 8.

In the two-color printing, the color materials to be used are limited. However, the color saturation in the image is unlikely to be lost, and the lighting effect using a color in the document may be maintained.

However, in a case of a natural image such as a picture, parts where black is printed and parts where a designated color is printed are mixed. Due to the mixture, and the gray scale may be degraded.

In the toner-saving mode, the gray scale in a natural image is unlikely to be degraded, but, the characters and the lines are likely to be seamless. Therefore, the image quality may be degraded in an image including many characters and lines.

Based on the above, when an occupancy ratio of the image object in the image data is high (YES in step S5), the toner-consumption reduction mode determination section 5 selects the toner-saving mode (step S6). On the other hand, when an occupancy ratio of the graphic object in the image data is high (NO in step S5), the toner-consumption reduction mode determination section 5 selects the two-color printing (step S7).

When the toner-saving mode is selected in step S6, the γ conversion section 7 reduces the image density of the input image data 1 in accordance with the toner-saving ratio in FIG, 8.

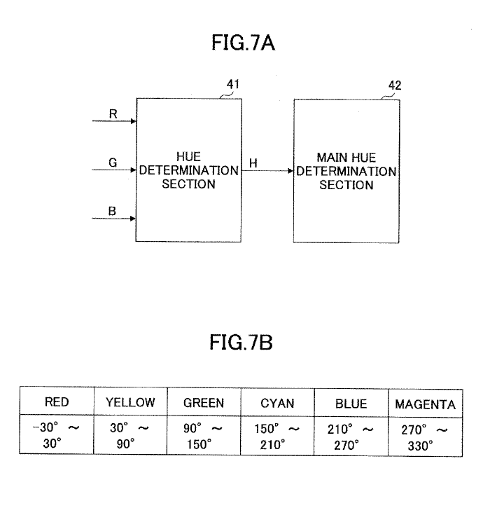

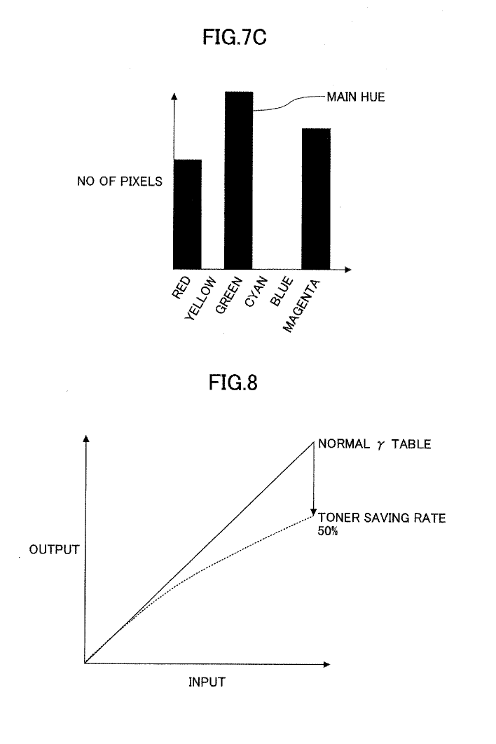

When the two-color printing is selected in step S8, a main (dominant) hue in the image data is selected from among cyan, magenta, yellow, red, green, and blue hues, so that the optimal designated in accordance with the hue of the image data is selected (step S9). The method of selecting the designated color will be described in FIGS. 7A through 7C.

Based on the process described above, it may become possible to automatically determine which of the monochrome printing, the toner-saving printing, and the two-color printing is appropriate (optimal) for the image data without bothering the user. Further, it may become possible to automatically determine (set) the optimal designated color to be used in the two-color printing in accordance with the image without bothering the user.

FIG. 3 illustrates an example configuration of the color saturation determination section 3. The color saturation determination section 3 determines the color saturation based on the color of the object so as to determine whether there exists image data having high color saturation in the draft. To that end, a color saturation calculation section 31 convers the input image data described in RGB data into the color saturation data.

FIG. 4 illustrates conversion formulas. When such as the conversion formula (9) is applied to the image data, the converted color saturation data S are obtained. When S(S value)=0, the image data are complete achromatic data. The higher the S value becomes, the greater the color brightness becomes. In this description, a case is described where the HSV conversion is used as the conversion from the RGB data into the color saturation data.

However, there are various other methods similar to the method using the HSV conversion. Therefore, it should be noted that any appropriate method other than that using the HSV conversion may alternatively be used.

A chromatic color determination section 32 determines that there exists a color having high color saturation when the converted S value is greater than or equal to a predetermined value.

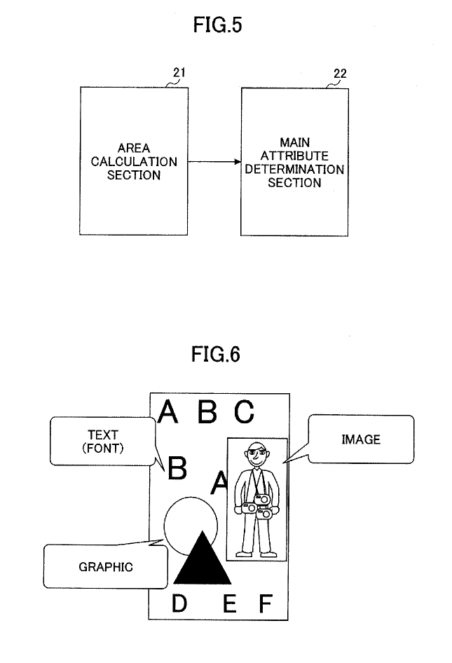

FIG. 5 illustrates an example configuration of the main attribute determination section 2. The image data described in a PDL is classified into three types: image, graphics, and text as illustrated in FIG. 6. An area calculation unit 21 of the main attribute determination section 2 calculates object image areas for each of the image, the graphic, and the text objects. The object image areas can be calculated based on the objection information described in the PDL.

A main attribute determination section 22 determines (selects) the object having the greatest area rate (having the highest frequency) as the main attribute in the image data from among the classified image, graphics, and text objects.

FIG. 7A illustrates an example configuration of the main hue determination section 4. The main hue determination section 4 determines the hue that is most frequently used among main six hues cyan, magenta, yellow, red, green, and blue in the color data of the image data. The hue is expressed using the letter “H” in the HSV conversion formulas of FIG. 4. The “H” may be expressed using an angle in a range from 0° to 360°. The main six hues are expressed as follows: red=0°, yellow=60°, green=120°, cyan=180°, blue=240°, and magenta=300°.

A hue determination section 41 calculates the “H” based on the RGB value in the image data, and determines the hue from among the main six hues. For example, if the calculated “H” is in a range from −30° to 30°, red is determined as the hue. FIG. 7B illustrates a hue determination table indicating the angle ranges of the main six hues.

A main hue determination section 42 counts the number of pixels in the image data for each of the main six hues as illustrated in FIG. 7C, and determines the hue having the greatest number of the pixels as the main hue. In the example of FIG. 7C, green is determined as the main hue.

The toner-consumption reduction mode determination section 5 selects the optimal designated color, and the color conversion section 6 converts the input image data 1 into the data of the two colors (i.e., black and the designated color). Further, the image forming section 8 prints the input image data 1 by the monochrome printing, the two-color printing, or the toner-saving printing to output the recorded image.

It should be noted that the present invention is not limited to the embodiment(s) described above. For example, the present invention may be realized by a general-purpose computer including the CPU, the memory and the like Further, the present invention further includes a program causing a computer to carry out the present invention described above.

According to an embodiment, it becomes possible to perform optimal low-cost printing in accordance with the image data to be printed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a first determination unit configured to determine an attribute of an image data described in a page description language;
a second determination unit configured to determine whether there exists a data having high color saturation in the image data;
a third determination unit configured to determine a main hue in the image data; and
a determination unit configured to determine an optimal printing method for printing the image data based on determination results by the first, the second, and the third determination units.

2. The image processing apparatus according to claim 1,
wherein the determination unit is configured to determine the optimal printing method from among monochrome printing, two-color printing, and toner-saving printing.

3. The image processing apparatus according to claim 1,
wherein the second determination unit is configured to determine whether there exists a data having color saturation greater than or equal to a predetermined color saturation.

4. The image processing apparatus according to claim 2,
wherein when the second determination unit determines that there exists no data having color saturation greater than or equal to a predetermined color saturation value, the determination unit is configured to select the monochrome printing.

5. The image processing apparatus according to claim 2,
wherein the attribute of the image data includes a graphic object, an image object, and a text object, and
wherein the first determination unit is configured to determine the attribute that is most frequently used in the image data based on areas of the graphic object, the image object, and the text object.

6. The image processing apparatus according to claim 5,
wherein when the first determination unit selects the image object as the attribute of the image data, the determination unit is configured to select the toner-saving printing.

7. The image processing apparatus according to claim 1,
wherein the third determination unit is configured to determine a hue that is most frequently used in the image data as the main hue from among six hues of cyan, magenta, yellow, red, blue, and green.

8. The image processing apparatus according to claim 2,
wherein the determination unit is configured to select a designated color to be used in the two-color printing in accordance with the main hue determined by the third determination unit.

9. An image processing method comprising:
a first determination step of determining an attribute of an image data described in a page description language;
a second determination step of determining whether there exists a data having high color saturation in the image data;
a third determination step of determining a main hue in the image data; and
a determination step of determining an optimal printing method for printing the image data based on determination results by the first, the second, and the third determination units.

10. A non-transitory recording medium storing a computer-readable program causing a computer to execute the image processing method according to claim 9.
